(19) United States
(12) Patent Application Publication
(10) Pub. No.: US 2010/0293759 A1
(43) Pub. Date: Nov. 25, 2010

(54) Shock absorbing apparatus for straps and ropes

(76) Inventor: Stanley Hiroshi Wada, Venice, CA (US)

Correspondence Address: Jerome E Sacks;Registered Patent Agent, PO Box 601, Lexington, MA, 02420, US

(21) Appl. No.: 12/800,696

(22) Filed: May 20, 2010

Related U.S. Application Data
(60) Provisional application No. 61/216,868, filed on May 22, 2009.

(51) Int. Cl. A44B 11/04; F16F 7/00

(52) U.S. Cl. 24/265 EC; 267/136

(57) ABSTRACT

An apparatus for providing a shock absorbing capability to a strap system is disclosed. A first embodiment of the shock absorbing apparatus presented herein, designed for use with a single flat strap, is comprised of two components, a bracket and a compressible member constructed out of foam, rubber, or similar material. The bracket has two loops that the strap feeds through and a third loop that allows the compressible member to be attached to it. The compressible member and bracket are sized and configured so it can be coupled with the single strap in a manner that provides a shock absorbing capability to the strap system. When the strap is tensioned, it presses against the compressible member and compresses it, providing a shock absorbing effect. Multiple additional embodiments are presented that accommodate one or two straps and singular or multiple compressible members.

### CROSS-REFERENCE TO RELATED APPLICATIONS

This application claims the benefit of the U.S. Provisional Patent Application No. 61/216,868 filed May 22, 2009 by the present inventor. This provisional patent application is incorporated herein by reference.

### TECHNICAL FIELD

This invention relates to shock absorbing apparatus that attaches to one or more straps, ropes, or similar items.

### BACKGROUND OF THE DISCLOSURE

Strap systems are used by many products such as backpacks, briefcases, golf clubs, dog leashes, safety harnesses, tow straps, child car seats, safety lanyards, boat mooring lines, and climbing equipment. Often the weight or pull on such a strap system causes undue strain on the straps of the strap system, and on the seams where the straps are attached to the product. When used in products that involve a user, the strap system may cause discomfort to the user when a force is applied to the strap system.

There exists several types of apparatus that address this problem; however they are either complex in design, not pleasing in appearance, or are not easily attached and removed from the strap system. When ropes instead of straps are used, similar problems occur.

### SUMMARY OF THE DISCLOSURE

The shock absorbing apparatus of the present invention is comprised of two components: a bracket system, and one or more compressible members, and coupling of the bracket system and each compressible member to a strap system. The compressible member is constructed out of foam, rubber, or similar material, and may have additionally an optional retaining mechanism that keeps the compressible member attached to the bracket.

Multiple embodiments are presented, describing various implementations of the shock absorbing apparatus. In a first set of embodiments, the bracket system is comprised of a single bracket that together with the compressible member, couples with a strap system comprised of a single strap. The bracket system has loops that a single strap feeds through. When the strap is tensioned by applying opposing forces to the strap, the strap presses against the compressible member and compresses the compressible member against the bracket system until the compressible member reaches a maximum deflection point. The compression rate of the compressible member ranges from zero deflection (no tension on the strap) to maximum deflection and creates the shock absorption properties for the strap. During the return of the strap from full compression to zero compression, the strap rubs slightly against the bracket to provide a minimal, frictional force to slow the return. This prevents an abrupt rebound of force that would pull back onto the strap and create a bouncing motion.

In a second set of embodiments, the shock absorbing apparatus is also comprised of a bracket system and at least one compressible member. In this second set of embodiments however, the bracket system is comprised of a plurality of rectangular loops that, together with the compressible member, couples with a strap system comprised of a pair of straps. The two straps, when coupled with the shock absorbing apparatus, emanate from opposing ends of the shock absorbing apparatus. When opposing linear forces on are applied to the two straps, the forces translate into compression of the compressible member, thereby providing a shock absorbing capability to the strap system.

### BRIEF DESCRIPTION OF THE DRAWINGS

FIG. 1A illustrates an exploded view of a first embodiment of the present invention.

FIG. 1B illustrates a perspective view of the first embodiment of the present invention with a strap attached.

FIG. 2A illustrates two sectional views of the first embodiment of the present invention.

FIGS. 2B-1 and 2B-2 illustrate front sectional views of the first embodiment of the present invention when the strap is relaxed and when it is under tension.

FIGS. 2C-1 and 2C-2 illustrate side sectional views of the first embodiment of the present invention when the strap is relaxed and when it is under tension.

FIGS. 3A, 3B, and 3C illustrate alternate designs for the bracket of the first embodiment of the present invention.

FIGS. 4A and 4B illustrate the bracket and compressible member for a second embodiment of the present invention.

FIG. 4C illustrates a front perspective view of the second embodiment of the present invention.

FIG. 4D illustrates a front sectional view of the second embodiment of the present invention.

FIG. 4E illustrates a front perspective view of the second embodiment of the present invention with the strap attached.

FIGS. 4F and 4G illustrate front sectional views of the second embodiment of the present invention when the strap is relaxed and when it is under tension.

FIGS. 5A and 5B illustrate the bracket and compressible member of a third embodiment of the present invention.

FIG. 5C illustrates the third embodiment of the present invention as applied to a rope.

FIG. 6 illustrates a perspective view of a fourth embodiment of the present invention applied to a carrying bag.

FIG. 7A illustrates a perspective view of a fifth embodiment of the present invention comprised of two rectangular loops coupled to two straps in a symmetrical strap configuration using a retaining loop.

FIG. 7B illustrates a sectional view of FIG. 7A.

FIG. 8A illustrates a perspective view of a sixth embodiment of the present invention comprised of two rectangular loops coupled to two straps in a nonsymmetrical strap configuration using a retaining loop.

FIG. 8B illustrates a sectional view of FIG. 8A.

FIG. 9A illustrates a perspective view of a seventh embodiment of the present invention comprised of three rectangular loops coupled to two straps of the strap system using a retaining loop.

FIG. 9B illustrates a sectional view of FIG. 9A.

FIG. 9C illustrates a perspective view of an eighth embodiment of the present invention that uses two compressible members.

FIG. 9D illustrates a perspective view of a ninth embodiment of the present invention that uses a cover as its retaining mechanism.

### DETAILED DESCRIPTION

In this specification, terms such as top, bottom, left, right, front, back, above and below refer to the figure where the reference occurs. The numerals used in the figures are the same for like parts.

In this specification and the amended claims, the following terms are defined. The term bracket system refers to either a single bracket that couple a single strap with a compressible member, or a plurality of predominately rectangular loops that couple two straps to a compressible member. The term strap system refers to either a single strap, if coupled with a bracket system comprised of a single bracket; or to two straps, if coupled with a bracket system comprised of a plurality of predominately rectangular loops. The strap system is not part of the present invention. Typically straps are either flat straps or ropes, but other types of straps may be used. Similarly, rectangular loops typically have a rectangular shaped cavity; however other cavity shapes such as racetrack shaped, ellipse shaped or D ring shaped may be used, to match a particular strap.

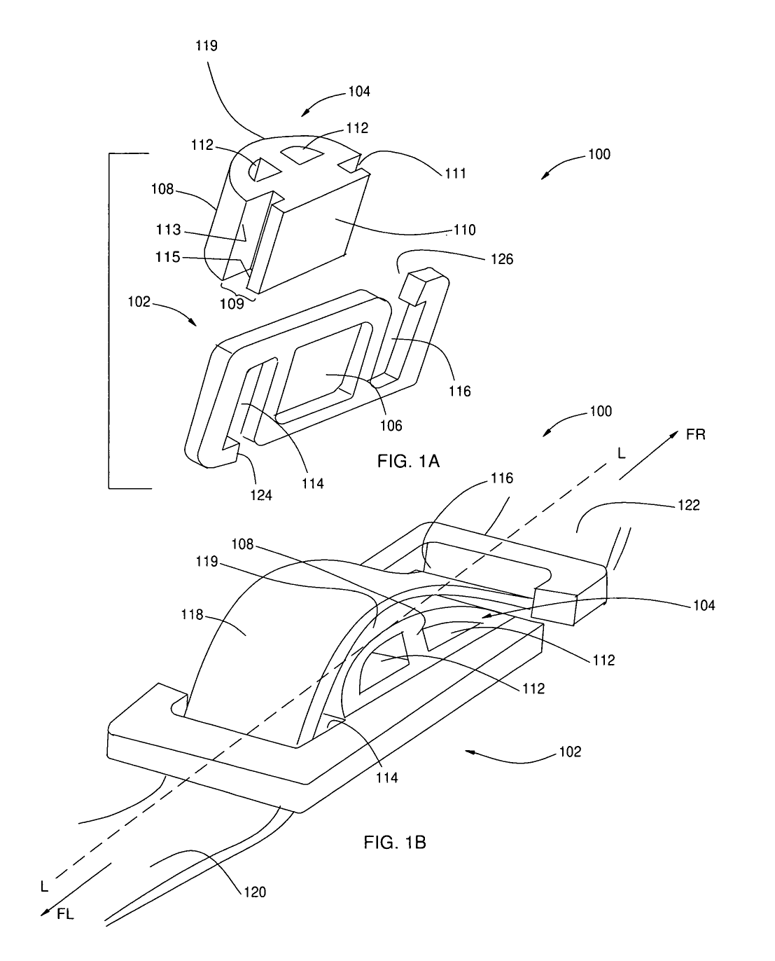

FIG. 1A illustrates an exploded view of a first embodiment 100 of the present invention. Referring to FIG. 1A, first embodiment 100 is comprised of a bracket system comprised of a rectangular bracket 102 and a compressible member 104. Compressible member 104 is comprised of two components; a concave downward (as seen from the front) top component 108, and a bottom component 109 comprised of a flat bottom section 110 and a middle section 111. Bracket 102 has two rectangular loops, a left loop 114, and a right loop 116.

FIG. 1B illustrates a coupling of first embodiment 100 to a strap system 118 such that creating opposing forces FL and FR on strap system 118 along strap longitudinal L axis of strap system 18 results in compression of the compressible member 104. The coupling of the first embodiment 100 to the strap system 118 is accomplished as follows: The two loops 114 and 116 are positioned towards the left and right ends of bracket 102. Flat strap 118 passes through the left loop 114, over the surface 119 on the top component 108 of compressible member 104 and then through right loop 116. Top component 108 and bottom component 109 of compressible member 104 are configured as shown in FIG. 1A to form a single unit. Compressible member 104 has two optional cavities 112 passing through it from front to back, contributing to the flexibility of compressible member 104 when a compressive force is applied to top component 108.

Middle section 111 of compressible component 109 is configured and sized so it fits snugly within loop 106 of bracket 102. Top component 108 has a bottom ledge 113 that fits on top left side and right side of loop 106. Bottom section 110 of compressible component 109 has ledges 115 that fit against the left and right sides of loop 106. The sizes of these ledges are configured so that the compressible member 104 remains securely in loop 106 when there are no stresses applied to it. If the top component 108 is compressed, ledges 113 on top component 108 will prevent compressible member 104 from falling through loop 106. However, ledges 115 of bottom section 110 are sized so compressible member 104 can be removed when sufficient pressure is applied to compressible member 104.

Referring to FIGS. 1A and 1B, a flat strap 118 is engaged with first embodiment 100 by traversing from bottom to top through left loop 114, going over the surface 119 on the top component 108 of the compressible member 104 and then traversing through right loop 116 from top to bottom. When opposing forces FL and FR are applied to the left 120 and right 122 segments of strap 118 by pulling them away from each other along longitudinal axis L of strap 118, compressible member 104 compresses, acting as a shock absorber. This reduces the jerk on strap 118, and if an apparatus such as a backpack or golf club bag is attached to strap 118, the embodiment reduces discomfort to a person using the apparatus. In first embodiment 100, left loop 114 has a slot 124 located at the back of bracket 102 configured and sized so strap 118 fits snugly through it. Similarly, the right loop 116 has a slot 126 located at the front of bracket 102 configured and sized so the strap 118 fits snugly through it. With the slots 124 and 126 used together, the strap 116 may be slided through the slots when attaching first embodiment 100 to strap 118, but the bracket will otherwise constrains the strap from falling off first embodiment 100. Slots 124 and 126 are optional.

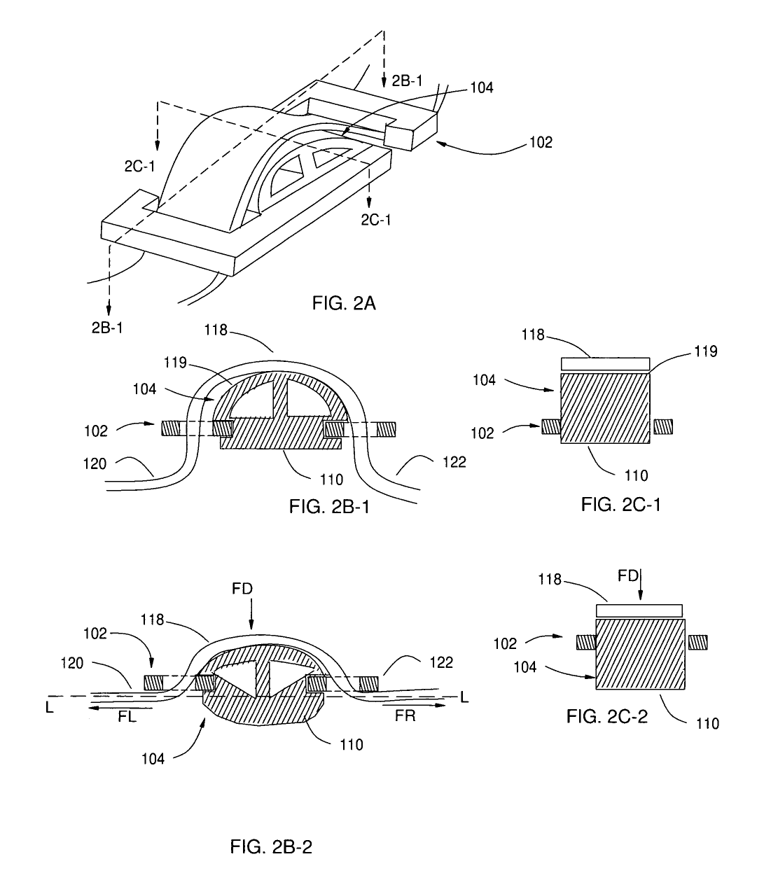

FIG. 2A illustrates two sectional views of first embodiment 100. FIG. 2B-1 illustrates a front sectional view of first embodiment 100 with strap 118 coupled to embodiment 100. The sectional view passes through the center of the bracket 102, perpendicular to the plane of bracket 102, and bisects compressible member 104. The sectional view 2B-1 illustrates the strap installed in a relaxed configuration without opposing forces on strap 118.

FIG. 2B-2 illustrates the same configuration as FIG. 2B-1; however, in FIG. 2B-2, strap ends 120 and 122 of the strap are forced away from each other in opposing directions FL and FR along strap longitudinal axis L. This creates a force FD downward by strap 118 on surface 119 on top component 108 of compressible member 104. When this occurs, compressible member 104 is compressed downward; causing bottom 110 of compressible member to 104 to bend downward, and the entire compressible member 104 is compressed. This compressing of the compressible member 104 relative to the bracket 102 provides a shock absorber effect on the strap.

FIGS. 2C-1 and 2C-2 illustrate a left side sectional view of first embodiment 100 with strap 118 attached. This section is taken through the center of the compressible member 104 bisecting compressible member 104 and is perpendicular to the bracket plane's front and back sides. FIG. 2C-1 illustrates strap 118 attached to first embodiment 100 in a relaxed position. FIG. 2C-2 illustrates the same configuration as FIG. 2C-1 with strap 118 installed on first embodiment 100; however in this case, as in FIG. 1B-2, the ends of the strap are forced away from each other so that tension applies a downward force FD on top component 108 of compressible member 104. When this occurs, compressible member 104 is compressed downward, providing a shock absorber effect on strap 118.

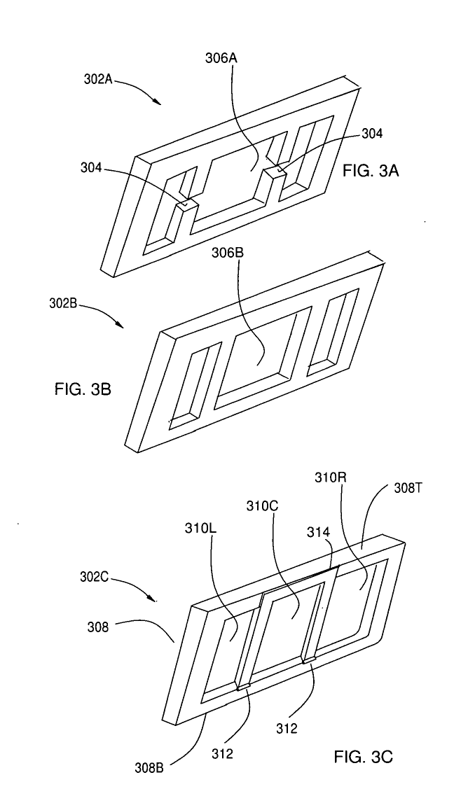

FIGS. 3A, 3B and 3C illustrate a first alternate bracket 302A, a second alternate bracket 302B, and a third alternate bracket 302C that may be used with first embodiment 100 by replacing bracket 102 of FIG. 1A with one of these alternate brackets. Referring to FIGS. 3A, 3B and 1B, first alternate bracket 302A has two slots 304 located on central loop 306A. The two slots 304 permit strap 118 to be easily inserted or removed from bracket 302A. FIG. 3B illustrates a second alternate bracket 302B of first embodiment 100. Alternate bracket 302B has no slots for inserting and removing the strap. Second alternate bracket 302B is stronger and simpler to manufacture as compared to the bracket 102 and first alternate bracket 302A. However, strap 118 can only be removed or added to the second alternate bracket 302B if there is a free end of strap. Therefore coupling of strap 118 with compressible member 104 and bracket 302B must be done before the free ends of strap 118 are secured to an object. Compressible member 104 is attached to second alternate brackets 302A and 302B in the same manner as it is attached to first bracket 102 illustrated in FIG. 1B.

FIG. 3C illustrates a third alternate bracket 302C of first embodiment 100. Refer now to FIGS. 3C and 1B. Alternate bracket 302C is comprised of an outer loop 308 and a central loop 310C that has two hinges 312 attached to the bottom leg 308B of outer loop 308, thereby dividing outer loop 308 into three loops 310L, 310C and 310R. Central loop 310C has a lip 314 that extends over the top leg 308T of outer loop 308. By raising the central loop 310C using hinges 312, compressible component 104 and strap 118 may be coupled to bracket 302C. By lowering the central loop 310C, bracket 302C may be secured. A snap (not show in the FIG. 3C) may be installed between lip 314 and the top leg 308T, further securing the coupling.

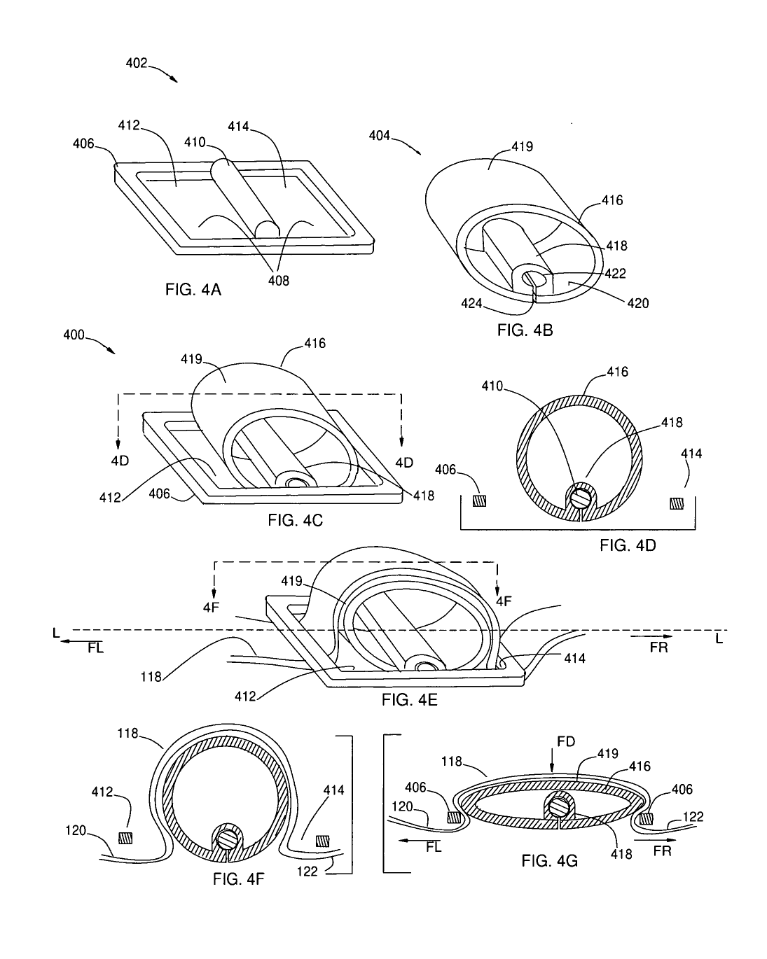

FIGS. 4A through 4G illustrate a second embodiment 400 of the present invention. Referring to FIGS. 4A and 4B, second embodiment 400 is comprised of a bracket 402 and a compressible member 404. Bracket 402 is comprised of a rectangular frame 406 with an interior rectangular loop 408 and a cylindrical shaft 410 permanently attached to the front and back sides of interior rectangular loop 408. Cylindrical shaft 410 separates bracket 402 into two openings, a left rectangular loop 412, and a right rectangular loop 414.

The compressible member 404 is comprised of a cylinder 416 with a hub 418 embedded in cylinder 416. Hub 418 extends from the front to the back of cylinder 416 and has a cylindrical cavity 422 configured to receive bracket shaft 410. The compressible member 404 has a cut 424 along the cylindrical cavity 422 where it is attached to the cylinder 416 so it can be removably attached to the cylindrical shaft 410 of bracket 402. FIGS. 4B through 4F has cylinder 416 having an approximately circular cavity 420; this cavity is optional.

FIG. 4C illustrates second embodiment 400 assembled and ready to receive strap 118 comprised of a single strap. Compressible member 404 may be attached to bracket 402 by spreading apart cut 424 and forcing hub 418 onto cylindrical shaft 410.

FIG. 4D illustrates a sectional view of second embodiment 400. The section, indicated on FIG. 4C, is taken perpendicular to the cylinder axis of rotation, and bisects cylinder 416.

FIG. 4E illustrates a coupling of second embodiment 400 to a strap system 118 such that creating opposing forces FL and FR on strap system 118 along strap longitudinal L axis of strap system 18 results in compression of the compressible member 404. Coupling is achieved by weaving strap 118 through second embodiment 400. This weaving is accomplished by passing strap 118 from bottom to top through first rectangular loop 412, going over the surface 419 of the cylinder 416, and then going through second rectangular loop 414 from top to bottom.

FIG. 4F illustrates a sectional view of second embodiment 400 with strap 118 attached and in a relaxed mode. For this configuration, there is no tension on the strap. FIG. 4G illustrates embodiment 400 with strap 118 attached and tension applied to strap 400. When strap ends 120 and 122 of strap 118 are forced away from each other in opposing directions FL and FR, along longitudinal direction L of strap 118, force FD is applied downward by strap 118 on the top of cylinder 416. This causes cylinder 416 to compress, temporarily reducing the tension on the strap and providing a shock absorber effect on strap 118.

As an alternate to second embodiment 400, cylindrical shaft 410 on bracket 402 can be hinged at one end, with a snap at the other end. The apparatus would work similar to the bracket 302C in FIG. 3C; the strap system 118 could be inserted and removed without a strap free end.

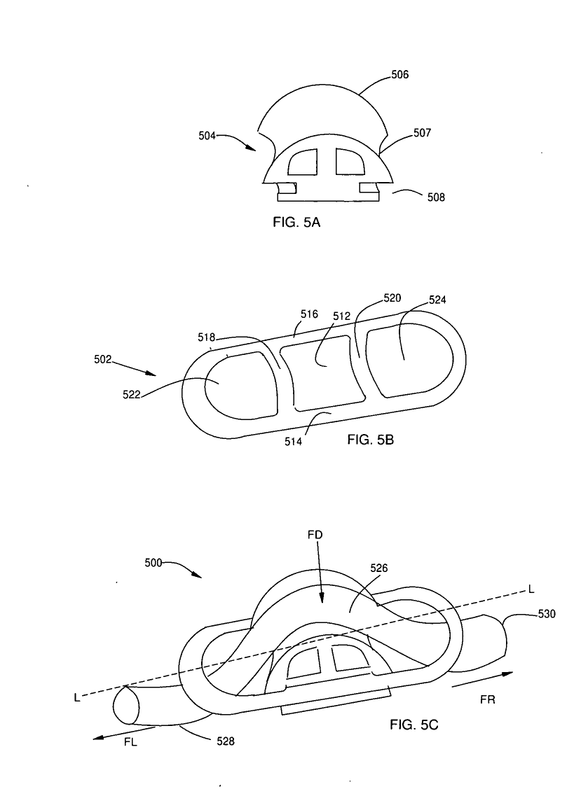

FIGS. 5A through 5D illustrate a third embodiment 500 of the present invention. Third embodiment 500 applies to a rope or cord instead of a flat strap. The construction and functioning of this embodiment is very similar to the first embodiment; therefore, only the differences between first embodiment 100 and third embodiment 500 are discussed here.

FIGS. 5A and 5B illustrate a bracket 502 and a compressible member 504 of third embodiment 500. The differences of these components as compared to those of first embodiment 100 are the following: The top component 506 of compressible member 504 has a concave shape 507 that acts as a guide for a rope. The bottom component 508 has a shape that matches a loop 512 of bracket 502.

Referring again to FIGS. 5A and 5B, bracket 502 has loop 512 in the center of bracket 502 that has a front 514 and a back 516 that are parallel and has concave inward left side 518 and right side 520. The left loop 522 and right loop 524 have shapes that accommodate a rope 526. FIG. 5C illustrates third embodiment 500 coupled with a strap system comprised of a rope 526.

FIG. 5C illustrates a coupling of third embodiment 500 to a strap system 118 such that creating opposing forces FL and FR on strap system 530 along strap longitudinal L axis of strap system 526 results in compression of the compressible member 504. When rope 526 is relaxed, compressible member 504 is not compressed. When the ends 528 and 530 of rope 526 are pulled apart by applying forces in opposing directions FL and FR along rope longitudinal axis L, the portion of rope 526 on the top of the compressible member transmits a force FD downward compressing compressible member 504. The same dynamics as shown in FIGS. 2B-1 and 2B-2 apply in the same way for third embodiment 500.

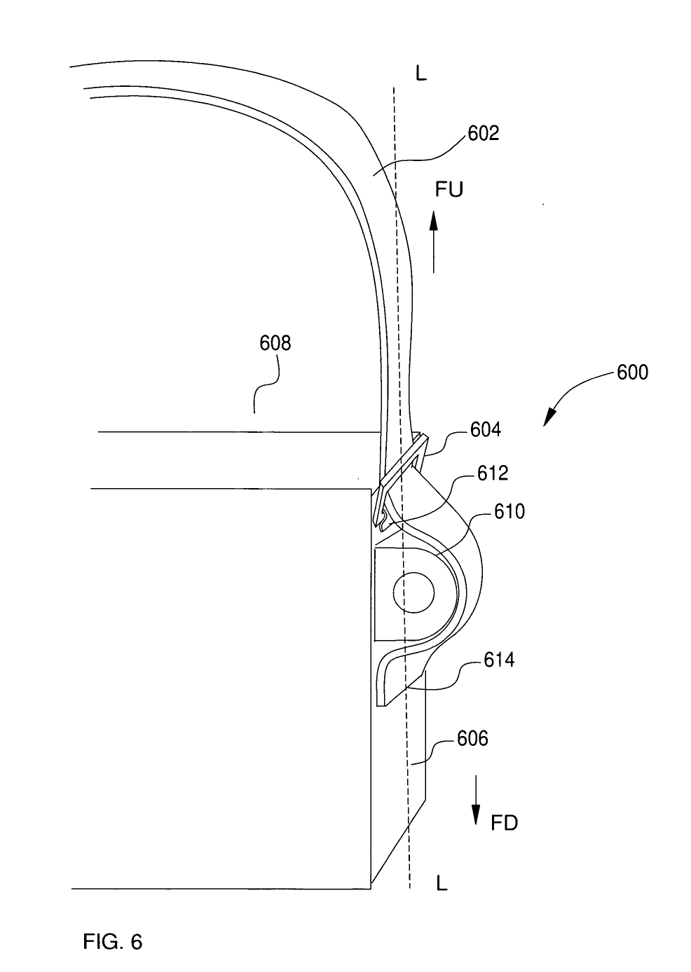

FIG. 6 illustrates a coupling of fourth embodiment 600 to a strap system 602 such that creating opposing forces FU and FD on strap system 602 along strap longitudinal L axis of strap system 602 results in compression of the compressible member 610. Fourth embodiment 600 uses a single strap 602 as the strap system, and has a single rectangular loop 604 as the bracket system. Fourth embodiment 600 is attached to a side 606 of a carrying bag 608 using strap system 602. Both strap system 602 and carrying bag 608 are not part of the invention. Referring to FIG. 6, fourth embodiment 600 uses a compressible member 610 attached to side 606 of carrying bag 608. Single loop 604 is movably attached to side 606 of carrying bag 608 above compressible member 610 using a small piece of material 612, and a first end 614 of strap system 602 is attached to side 606 below compressible member 610. Lifting strap 602 raises carrying bag 608; the weight of carrying bag 608 causes opposing forces FU and FD. Although not illustrated in FIG. 6, an apparatus of fourth embodiment 600 attaches strap system 602 to the left side of carrying bag 608.

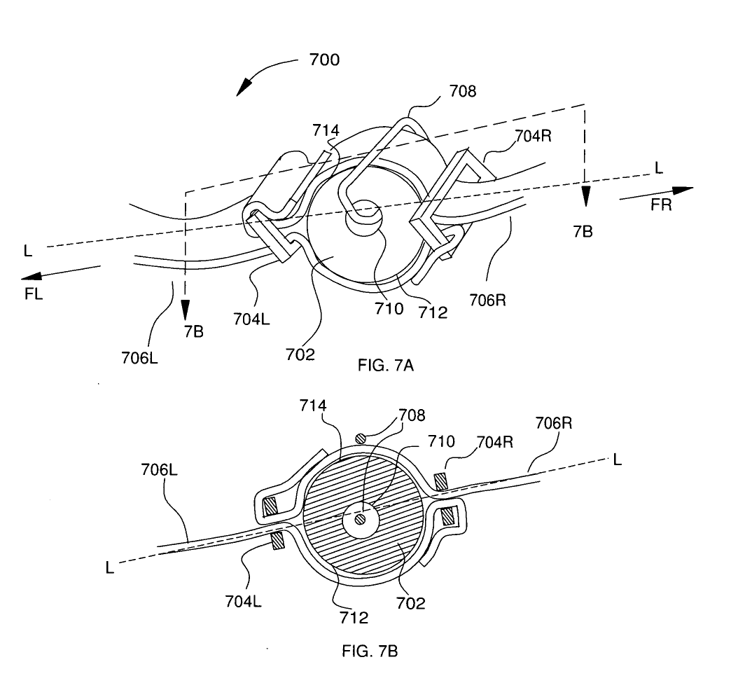

FIG. 7A illustrates a perspective view of a fifth embodiment 700 of the present invention. FIG. 7B illustrates a sectional view of FIG. 7A. Fifth embodiment 700 has a compressible member 702 with an optional retainer loop 708, and a bracket system 704 comprised of a first rectangular loop 704L and a second rectangular loop 704R. Bracket system 704 couples with a strap system 706 comprising a first strap 706L and a second strap 706R. FIGS. 7A and 7B illustrate a coupling of fifth embodiment 700 to a strap system 706 such that creating opposing forces FL and FR on strap system 706 along strap longitudinal L axis of strap system 706 results in compression of compressible member 702. Strap system 706 is not part of the invention. Referring to FIG. 7A, the coupling of fifth embodiment 700 to a strap system 706 is the following: First strap 706L passes through first loop 704L, goes under and wraps around the bottom surface 712 of compressible member 702, and then is attached to second loop 704R on the bottom part of the loop. Second strap 706R passes through second loop 704R, goes over the top surface 714 and wraps around compressible member 702, and then is attached to first loop on the top part of first loop 704L. When opposing forces FL and FR are applied to first strap 706L and second strap 706R of strap system 706 along longitudinal axis L of strap system 706, compressible member 702 is compressed, providing a shock absorbing effect to strap system 706.

Referring to FIGS. 7A and 7B, a device for retaining the apparatus to the strap system is accomplished by using a rectangular retainer loop 708. Retainer loop 708 has one side passing through a cylindrical cavity 710 located in compressible member 702. Second strap 706R passes through rectangular retainer loop 708, thereby holding compressible member 702 in place when there is slack in the strap system.

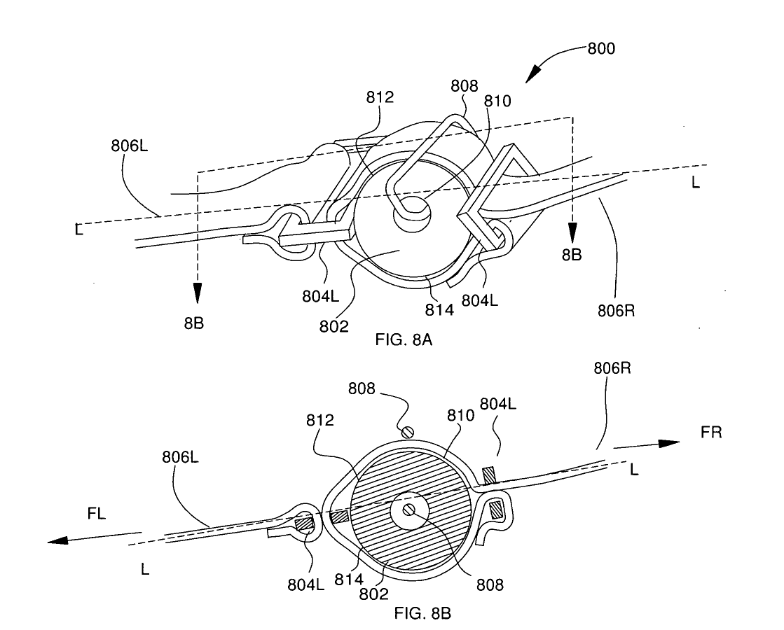

FIG. 8A illustrates a perspective view of a sixth embodiment 800 of the present invention. FIG. 8B illustrates a sectional view of FIG. 8A. Sixth embodiment 800 uses a bracket system 804 comprised of a first rectangular loop 804L, a second rectangular loop 804R, and a compressible member 802 having an optional retainer loop 808. FIGS. 8A and 8B illustrate a coupling of sixth embodiment 800 to a strap system 806 such that creating opposing forces FL and FR on strap system 806 along strap longitudinal L axis of strap system 806 results in compression of compressible member 802. Coupling means is achieved as follows. First strap 806L is attached to first rectangular loop 804L at a first strap end 808L. Second strap 806R passes through second loop 804R, goes over and wraps around the top surface 812 of compressible member 802, goes through second loop 804R, then wraps over the bottom 814 surface of compressible member 802, and then is attached to the second loop 804R. When opposing forces FL and FR are applied to first strap 806L and second strap 806R along longitudinal axis L, compressible member 802 is compressed, providing a shock absorbing effect to strap system 806.

Referring to FIGS. 8A and 8B, an optional rectangular retainer loop 808 may be incorporated. Optional retainer loop 808 has one side passing through a cylindrical cavity 810 located in compressible member 802. Second strap 806R passes through rectangular retainer loop 808, thereby holding compressible member 802 in place when there is slack in the strap system.

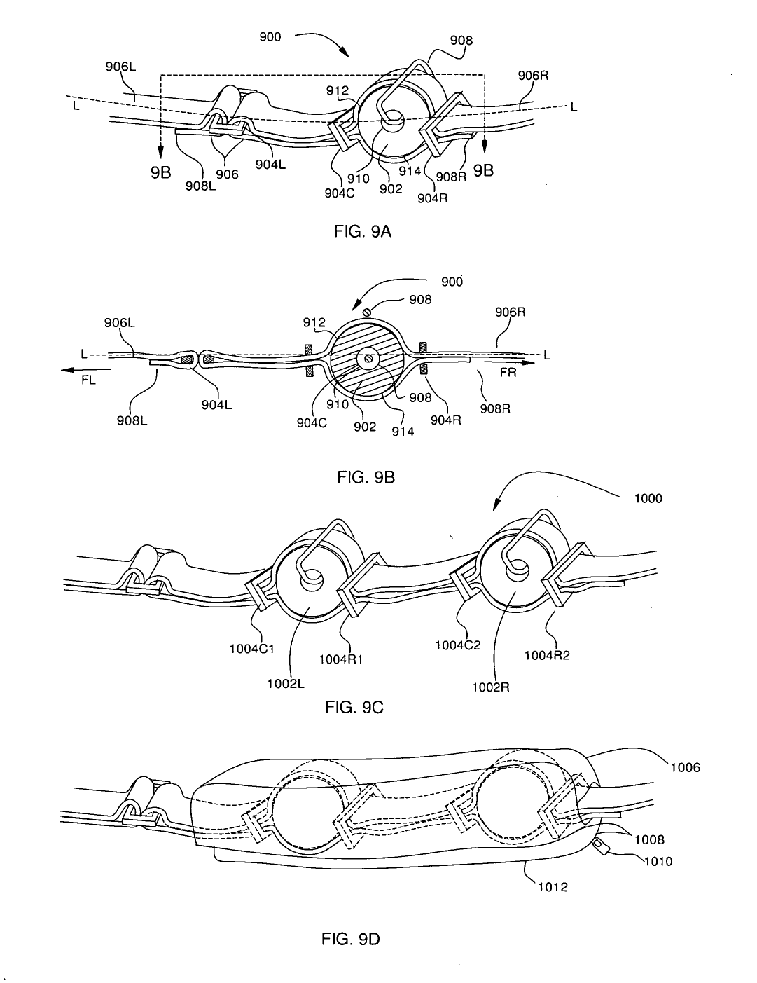

FIG. 9A illustrates a perspective view of a seventh embodiment 900 of the present invention. FIG. 9B illustrates a sectional view of FIG. 9A. Seventh embodiment 900 uses a bracket system comprised of a first rectangular loop 904L, a second rectangular loop 904C, a third rectangular loop 904R and a compressible member 902 having an optional retainer loop 908. FIGS. 9A and 9B illustrate a coupling of seventh embodiment 900 to a strap system 906 such that creating opposing forces FL and FR on strap system 906 along strap longitudinal L axis of strap system 906 results in compression of compressible member 902. Coupling is achieved as follows. Strap system 906 is comprised of a first strap 906L and a second strap 906R. Referring to FIG. 9A, first strap 906L has a first strap end 908L attached to first rectangular loop 904L. Second strap 906R has a second strap end 908R. Second strap 906R passes through the third loop 904R, goes over and wraps around the top surface 912 of compressible member 902, goes through second loop 904C, then wraps around under the bottom surface 914 of compressible member 902, and then goes through third loop 904R. Second strap end 908R is attached to second strap 904R securing strap 906R to third loop 904R. When opposing forces FR and FL are applied to the first strap 906L and second strop 906R along longitudinal axis L, compressible member 902 is compressed, providing a shock absorbing effect to strap system.

Referring to FIGS. 9A and 9B, an optional rectangular retainer loop 908 may be incorporated. Optional retainer loop 908 has one side passing through a cylindrical cavity 910 located in compressible member 802. Second strap 906R passes through rectangular retainer loop 908, thereby holding compressible member 902 in place when there is slack in the strap system.

FIG. 9C illustrates a perspective view of an eighth embodiment 1000 of the present invention. Eight embodiment 1000 is similar to the seventh embodiment 900. However, eighth embodiment 1000 uses two compressible members 1002L and 1002R instead of one, and uses two sets of rectangular loops. Rectangular loops 1004C1 and 1004R1 are coupled with compressible member 1002L and rectangular loops 1004C2 and 1004R2 are coupled with compressible member 1002R. FIG. 9C also illustrates the use of two optional retainer loops 1008L ands 1008R. They are used in a manner similar to retainer loops 908 and 808 of fifth embodiment 700 and sixth embodiment 800.

FIG. 9D illustrates a ninth embodiment 1100. Ninth embodiment 1100 modifies eighth embodiment 1000 by employing a device for retaining the apparatus to the strap system by using a cover 1006 instead of the retaining loops of the previous embodiments. Cover 1006 fits over eighth embodiment 1000 and has a flap 1012 that closes with a zipper 1008 that permits its installation.

The type of material and shape of the material for the compressible members varies by application based on the need for more or less shock absorption. For example, lightweight, open celled foam may be used for low duty loads and a higher hardness rubber may be used for heavier duty loads. The bracket material, thickness, and dimensions also vary by application based on the physical strength needed for the force being applied to it. Other compressible material such as an air filled bladder may also be used for the compressible member.

The disclosure presented herein gives multiple embodiments of the present invention. These embodiments are to be considered as only illustrative of the present invention and not a limitation of the scope of the present invention. Various permutations, combinations, variations, and extensions of these embodiments are considered to fall within the scope of this invention. Therefore, the scope of this invention should be determined with reference to the claims and not just by the embodiments presented herein.

What is claimed is:

1. An apparatus for providing a shock absorbing capability to a strap system, the strap system having a longitudinal axis, the apparatus comprising:
a compressible member, the compressible member;
a coupling of the apparatus to the strap system such that creating opposing forces on the strap system along the longitudinal axis results in compression of the compressible member.

2. The apparatus for providing a shock absorbing capability to a strap system of claim 1, wherein the compressible member has cavities positioned transverse to the longitudinal direction of the strap system when the apparatus is coupled to the strap system.

3. The apparatus for providing a shock absorbing capability to a strap system of claim 1 wherein the strap system is comprised of at least one flat strap.

4. The apparatus for providing a shock absorbing capability to a strap system of claim 1 wherein the apparatus has a device for retaining the apparatus to the strap system.

5. The apparatus for providing a shock absorbing capability to a strap system of claim 1 in which:
the strap system is comprised of a single strap;
the bracket system is comprised of a bracket having a first rectangular loop, a second rectangular loop, and a third rectangular loop, the second rectangular loop being positioned between the first rectangular loop and the third rectangular loop;
the compressible member has a first component that has a shape of a segment of a cylinder, and a second component that is attachable to the second rectangular loop.

6. The apparatus for providing a shock absorbing capability to a strap system of claim 1 wherein
the strap system is comprised of a single strap having a first end and a second end;
the apparatus has the capability for removing the strap from the apparatus without having access to the end or the second end; and
the apparatus has the capability for securing the strap to the apparatus without having access to the end or the second end.

7. The apparatus for providing a shock absorbing capability to a strap system of claim 1 in which:
the strap system is comprised of a single strap;
the bracket system is comprised of a bracket having a first rectangular loop, a second rectangular loop, and a shaft positioned between the first rectangular loop and the second rectangular loop, the shaft forming a common side of the first rectangular loop and the second rectangular loop; and
the compressible member having a cylindrical shape, the compressible member additionally having a hub attachable to the shaft; the compressible member having a first surface.

8. The apparatus for providing a shock absorbing capability to a strap system of claim 7 in which:
the coupling of the apparatus to the strap system is achieved by the strap system passing through the first loop, the strap system additionally passing around the first surface of the compressible member, and the strap system additionally passing through the second loop.

9. The apparatus for providing a shock absorbing capability to a strap system of claim 1 in which:
the strap system is comprised of a first strap having a first strap end and a second strap having a second strap end;
the bracket system is comprised of a first rectangular loop and a second rectangular loop;
the compressible member having a cylindrical shape, the compressible member having a first surface and a second surface;
the coupling of the strap system to the apparatus is comprised of:
the first strap passing through the first loop, the first strap additionally passing around the first surface of the compressible member, the first end being attached to the second loop; and
the second strap passing through the second loop, the second strap additionally passing around the second surface of the compressible member, and the second end being attached to the first loop.

10. The apparatus for providing a shock absorbing capability to a strap system of claim 1 in which:
the strap system is comprised of a first strap having a first end and a second strap having a second end;
the bracket system is comprised of a first rectangular loop and a second rectangular loop;
the compressible member having a cylindrical shape, the compressible member having a first surface and a second surface;
the coupling of the strap system to the apparatus is comprised of:
the first end being attached to the first loop;
the second strap passing through the second loop, the second strap additionally passing around the first surface of the compressible member, the second strap additionally passing through the first loop, the second strap additionally passing around the second surface of a compressible member, the second end additionally being attached to the second loop.

11. The apparatus for providing a shock absorbing capability to a strap system of claim 1 in which:
the strap system is comprised of a first strap having a first end and a second strap having a second end;
the bracket system is comprised of a first rectangular loop, a second rectangular loop, and a third rectangular loop;
the compressible member having a cylindrical shape, the compressible member having a first surface and a second surface;
the coupling of the strap system to the apparatus is comprised of:
the first end being attached to the first loop;
the second strap passing through the third loop, the second strap additionally passing around the first surface of the compressible member, the second strap additionally passing through the second loop, the second strap additionally passing through the first loop, the second strap additionally passing through the second loop, the second strap additionally passing around the second surface of the compressible member, and the second end additionally being attached to the third loop.

12. The apparatus for providing a shock absorbing capability to a strap system of claim 11 additionally comprising at least one additional compression member and at least two additional rectangular loops, wherein the additional compression member and at least two additional loops are coupled with the second strap.

13. An apparatus for providing a shock absorbing capability to a strap system, the strap system being comprised of a single flat strap, the flat strap having a longitudinal axis, the apparatus comprising:
a bracket system comprised of a bracket having a first rectangular loop, a second rectangular loop, and a third rectangular loop, the second rectangular loop positioned between the first rectangular loop, and the third rectangular loop;
a compressible member, the compressible member comprised of a first component having a shape of a cylindrical segment, and a second component having a shape configured to be attachable to the second rectangular loop;
the flat strap capable of being coupled to the apparatus by passing the flat strap through the first rectangular loop, additionally passing the flat strap around a the first component of the compressible member, and additionally passing the flat strap through the third rectangular loop.

14. An apparatus for providing a shock absorbing capability to a strap system having a longitudinal axis, the strap system comprised of a first strap having a first end and a second strap having a second end, the apparatus comprising:
a bracket system comprised of at least two rectangular loops;
a compressible member, the compressible member being comprised of a compressible cylinder having a first surface and a second surface;
a coupling of the apparatus to the strap system in a way such that creating opposing forces on the strap system along the longitudinal axis of the strap system results in compression of the compressible member.

15. The apparatus of claim 14 in which the coupling of the apparatus to the strap system is comprised of:
the first strap passing through the first rectangular loop, the first strap additionally passing around the first surface of the compressible member, and the first strap additionally having the first end attached to the second rectangular loop; and
the second strap passing through the second rectangular loop, the second strap additionally passing around the second surface of the compressible member, and additionally the second end attached to the first rectangular loop.
